(19) United States
(12) Patent Application Publication
(10) Pub. No.: US 2019/0080124 A1
(43) Pub. Date: Mar. 14, 2019

(54) SYSTEM AND METHOD FOR LOCATING ONE OR MORE OF PRODUCTS THAT ARE MISPLACED BY A USER

(71) Applicant: Anand Vaidyanathan, Chennai (IN)

(72) Inventor: Anand Vaidyanathan, Chennai (IN)

(21) Appl. No.: 15/873,881

(22) Filed: Jan. 17, 2018

(30) Foreign Application Priority Data
Sep. 9, 2017 (IN) 201741031957

(51) Int. Cl. G06K 7/10; G06K 1/12; G06K 7/14

(52) U.S. Cl. CPC G06K 7/10722; G06K 7/1417; G06K 1/121

(57) ABSTRACT

A method for locating one or more products that are misplaced by a user (102) is provided. The method includes (i) printing, a QR code (116) on a product (114) with one or more details associated with the product (114), (ii) registering, the product (114) with the user (102) using the QR code (116) associated with the product (114), (iii) obtaining a user data from the user (102) through the user device (104), (iv) obtaining QR codes of the one or more products from the user device (104), (v) creating an ownership for the product (114) by associating the user data with the QR code (116) that is specific to the product (114), (vi) identifying a finder (110) who has the product (114) that is misplaced or missed by the user (102) when the finder (110) scan the QR code (116) of the product (114) using a finder device (112).

### CROSS-REFERENCE TO RELATED APPLICATIONS

This application claims priority to Indian patent application no. 201741031957 filed on Sep. 9, 2017, the complete disclosure of which, in its entirely, is herein incorporated by reference.

### BACKGROUND

### Technical Field

Embodiments of this disclosure generally relate to a product locator, more particularly, to a system and method for locating one or more products that are misplaced or missed by a user/an owner.

### DESCRIPTION OF THE RELATED ART

Most often people tend to misplace small personal items, such as cellular telephones, wallets, keys, and iPod, etc. due to their small size and light volume. The process of locating the misplaced personal items is extremely frustrating and time consuming. Individuals find themselves flipping couch cushions, searching the yard or the car, and tearing the house apart looking for the misplaced personal items. For example, when a cellular phone is misplaced and is turned off or the battery of the cellular phone is dead, there is no way to locate the cellular phone. Keys are one of the most common items to be misplaced due to small size. While traveling, important personal items, including, hotel keys and passports can go missing. There is no quick, easy way to locate items that have gone missing. Many individuals spend hours looking for misplaced personal items that may never be found. One method used to identify personal possessions is to label the items with the name and address of the owner. This has the disadvantage that the address of the owner may change and the labels will therefore be incorrect. To avoid this, the labels may be updated when the owner of the items changes addresses but such an operation is inconvenient and time consuming.

Accordingly, there remains need for a system and method for locating one or more products that are misplaced or missed.

### SUMMARY

In view of the foregoing, an embodiment herein provides a system for locating one or more products that are misplaced by a user. The system includes a QR code printing machine, a user device and a server. The QR code printing machine prints a unique QR code on each product. The QR code includes an encrypted data to identify a unique product identifier. The encrypted data includes a serial number of a product. The user device receives a user data from the user. The user device includes a camera to read QR codes of the one or more products. The server includes a memory and a processor. The memory stores (a) a set of modules and (b) a server database that stores data associated with one or more users and data associated with one or more finders. The processor which executes the set of modules. The set of modules includes a user data obtaining module, a QR code obtaining module, an ownership creating module and a finder identification module. The user data obtaining module obtains the user data from the user through the user device. The user data includes (i) the user device ID and (ii) an application ID. The QR code obtaining module obtains the QR codes of the one or more products from the user device. The ownership creating module creates an ownership for the product by associating the user data with the QR code that is specific to the product. The finder identification module identifies a finder who has the product that is misplaced or missed by the user when the finder scan the QR code of the product using a device that is other than the user device. The finder identification module (i) provides an alert notification to the user when the finder scans the QR code of the product and (ii) enables chat or call between the user and the finder. The alert notification includes the finder name, a contact detail of the finder and a location of the finder.

In one embodiment, the server further includes an ownership transferring module, implemented by the processor, that transfers the ownership of the one or more products to a second entity when the user sell or provide the one or more products to the second entity. The ownership transferring module associates data of the second entity with the respective QR codes of the one or more products to transfer the ownership to the second entity.

In another embodiment, the server further includes a product details identification module, implemented by the processor that identifies one or more details of the product when the QR code of the product obtained from the user device.

In one aspect a method for locating one or more products that are misplaced by a user is provided. The method includes steps of (i) printing, using a QR code printing machine, a QR code on a product with one or more details associated with the product, (ii) registering, using a user device, the product with the user using the QR code associated with the product once the user bought the product, (iii) obtaining, using a user data obtaining module, a user data from the user through the user device, (iv) obtaining, using a QR code obtaining module, QR codes of the one or moreproducts from the user device, (v) creating, using an owner ship creating module, an ownership for the product by associating the user data with the QR code that is specific to the product, (vi) identifying, using a finder identification module, a finder who has the product that is misplaced or missed by the user when the finder scan the QR code of the product using a device that is other than the user device, (vii) providing, using the finder identification module, (a) a location of a user device to the finder and (b) an alert notification to the user when the finder scans the QR code of the product and (viii) enabling, using the finder identification module, chat or call between the user and the finder.

In one embodiment, the QR code includes a unique product identifier.

In another embodiment, the user data includes (i) the user device ID and (ii) an application ID. In yet another embodiment, the method further includes the step of transferring, using an ownership transferring module, the ownership of the one or more products to a second entity when the user sell or provide the one or more products to the second entity. The ownership transferring module associates data of the second entity with the respective QR codes of the one or more products to transfer the ownership to the second entity.

In yet another embodiment, the method further includes the step of identifying, using a product details identification module, and one or more details of the product when the QR code of the product obtained from the user device.

In yet another embodiment, the method further includes the steps of (a) receiving, using the user device, the user data from the user and (b) reading, using a camera, the QR codes of the one or more products.

The system and method used to identify the misplaced products such as keys, wallets, mobile phones, laptops, handbags, and umbrella from various location. The system and method attempt to anonymize the communications between the user who misplaced the product and the finder by providing alert notification to the user when the finder scans the QR code of the misplaced product. The system and method also used to find children's using the QR codes of garments (e.g. clothes and shoes) which is printed on the garments that is worn by the children. The system and method used to find the children when the children get lost.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a system view of locating one or more products that are misplaced by a user using a location finding system according to the embodiment herein;

FIG. 2 illustrates an exploded view of the location finding system associated with the server of FIG. 1 according to an embodiment herein;

FIGS. 3A-3B are flow diagrams illustrating a method for locating one or more products that are misplaced by the user according to an embodiment herein;

FIG. 4 illustrates an exploded view of a receiver of FIG. 1 according to an embodiment herein; and

FIG. 5 illustrates a schematic diagram of computer architecture used in accordance with the embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

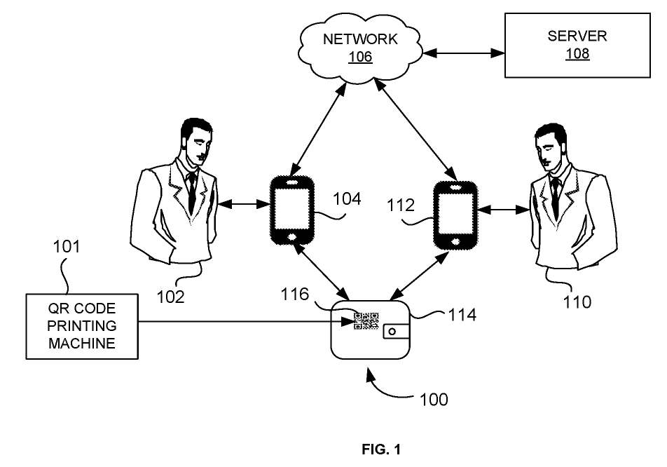

As mentioned, there remains a need there remains a need for a system and method for locating one or more products that are misplaced by a user. Referring now to the drawings, and more particularly to FIGS. 1 through 5, where similar reference characters denote corresponding features consistently throughout the figures, there are shown preferred embodiments.

FIG. 1 illustrates a system view of locating one or more products that are misplaced by a user 102 using a location finding system 100 according to the embodiment herein. The location finding system 100 includes a QR code printing machine 101, the user 102, a user device 104, a network 106 a server 108, a finder 110 and a finder device 112. The location finding system 100 further includes a product (e.g. a wallet 114) and a QR code 116. The QR code printing machine 101 prints the QR code 116 on the product (the wallet 114). The QR code 116 includes a unique identifier of the product (the wallet 114). In one embodiment, the QR codes are unique for each product. The QR code 116 includes an encrypted data to identify the product (the wallet 114) which includes a unique product identifier (e.g. a unique QR code associated with the product). In one embodiment, the QR code 116 of the product (the wallet 114) includes (a) a name and nature of the product (the wallet 114) and (b) a manufacture of the product (the wallet 114). In one embodiment, the encrypted data includes a serial number of the product (the wallet 114). In an embodiment, during manufacturing or labeling or packaging of the one or more products, the QR codes are attached to the one or more products by printing or by sticking a QR code label on each product.

The user 102 identifies location of the one or more products that are misplaced by the user 102 using the location finding system 100. In one embodiment, the one or more products are keys, wallets, mobile phones, laptops, handbags, umbrella, etc. The user 102 may be an owner of the product (the wallet 114). The location finding system 100 obtains a user data from the user 102 through the user device 104. In one embodiment, initially the location finding system 100 allows the user 102 to login or sign up to the location finding system 100. The user data includes (i) a user device ID and (ii) an application ID. In one embodiment, the user data further includes (i) a name of the user 102, (ii) an address of the user 102, (iii) a contact detail of the user 102 and (iv) one or more locations of the user 102. In another embodiment, the product (the wallet 114) is bought and registered with the user 102 by associating the user data with the QR code 116 of the product (the wallet 114). The user device 104 and the finder device 112 communicate with the server 108 using the network 106. In one embodiment, the network 106 is a wired network or wireless network. The user device 104 includes a camera to read QR codes of the one or more products. The location finding system 100 associates the QR codes of the one or more products with the user 102. In one embodiment, the location finding system 100 associates the QR codes of the one or more products with the user data. The location finding system 100 obtains the QR codes of the one or more products of the user 102 through the user device 104. The user device 104 communicates the user data and the QR codes of the product 114 to the server 108. The location finding system 100 identifies the finder 110 who has the product (the wallet 114) that is misplaced or missed by the user 102 when the finder 110 scan the QR code 116 of the product (the wallet 114) using the finder device 112 that is other than the user device 104. The location finding system 100 identifies location of the user device 104 via a Global positioning system (GPS) when the finder 110 scan the QR code 116 of the product (the wallet 114). The location finding system 100 identifies the location of the user device 104 using the user device ID associated with the QR code 116 of the product (wallet 114). The identification of the location of the user device 104 helps to return the misplaced or missed product (wallet 114) of the user 102. In one embodiment, the location finding system 100 identifies the location of finder 110 who has the product (the wallet 114) that is misplaced or missed by the user 102 using the Global positioning system (GPS) when the finder 110 scans the product (wallet 114). The location finding system 100 (i) provides an alert notification to the user 102 when the finder 110 scans the QR code 116 of the product (the wallet 114) and (ii) enables chat or call between the user 102 and the finder 110. The alert notification includes a name of the finder 110, a contact detail of the finder 110 and a location of the finder 110.

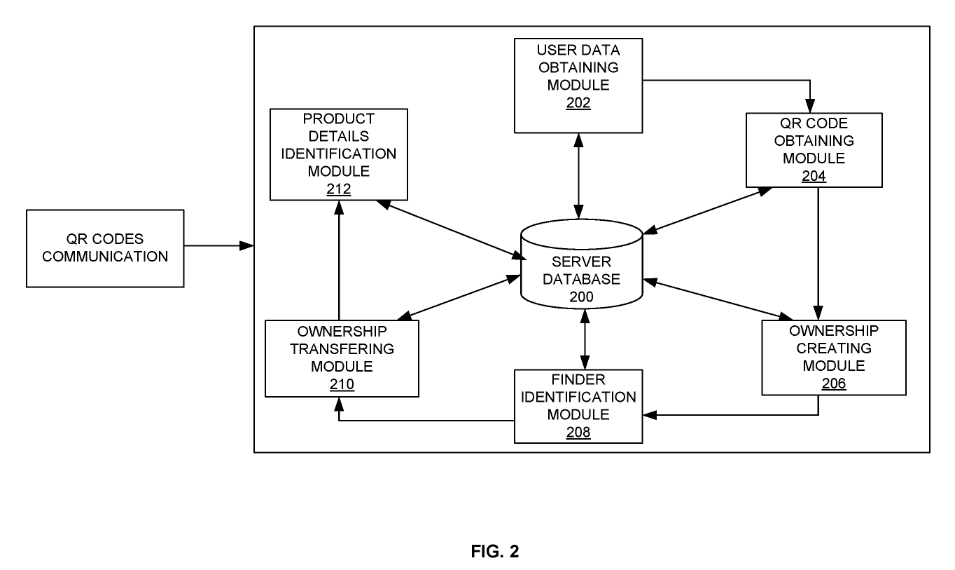

FIG. 2 illustrates an exploded view of the location finding system 100 associated with the server 108 of FIG. 1 according to an embodiment herein. The exploded view includes a server database 200, a user data obtaining module 202, a QR code obtaining module 204, an ownership creating module 206, a finder identification module 208, an ownership transferring module 210 and a product details identification module 212. The user data obtaining module 202 obtains the user data from the user 102 through the user device 104. The QR code obtaining module 204 obtains the QR codes of the one or more products from the user device 104. The ownership creating module 206 creates an ownership for the product (the wallet 114) by associating the user data with the QR code 116 that is specific to the product (the wallet 114). In one embodiment, the product (wallet 114) registered with the user 102 using the QR code 116 associated with the product (wallet 114) once the user 102 bought the product (wallet 114). The finder identification module 208 identifies the finder 110 (e.g. a location of the finder 110) who has the product (the wallet 114) that is misplaced or missed by the user 102 when the finder 110 scan the QR code 116 of the product (the wallet 114) using the finder device 112 that is other than the user device 104. In one embodiment, the finder identification module 208 identifies a location of the user device 104 when the finder scans the QR code 116 of the product (wallet 114). The finder identification module 208 (i) provides an alert notification to the user 102 when the finder 110 scans the QR code 116 of the product (the wallet 114) and (ii) enables chat or call between the user 102 and the finder 110. In one embodiment, the alert notification includes the name of the finder 110, the contact detail of the finder 110 and the location of the finder 110. The ownership transferring module 210 transfers the ownership of the one or more products to a second entity when the user 102 sells or provides the one or more products to the second entity. The ownership transferring module 210 (a) discards the user data associated with the respective QR codes of the one or more products and (b) associates data of the second entity with the respective QR codes of the one or more products to transfer the ownership to the second entity. The product details identification module 212 identifies one or more details of the product when the QR code 116 of the product (the wallet 114) obtained from the user device 104. Initially, the QR codes of the products are scanned and communicated to the server 108 through the user device 104.

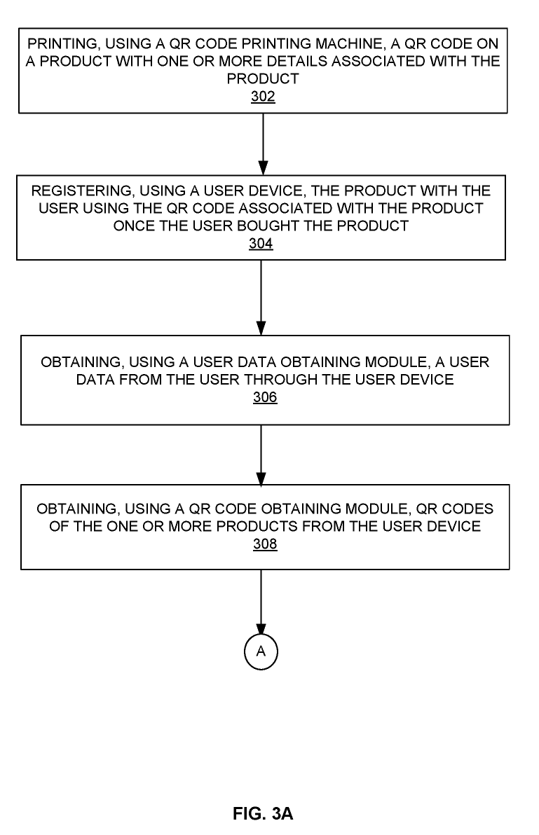

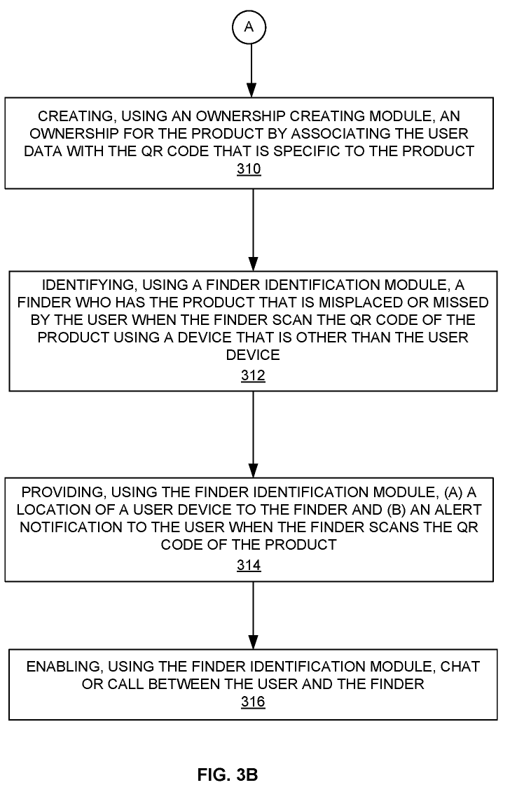

FIGS. 3A-3B are flow diagrams illustrating a method for locating the one or more products that are misplaced by the user 102. At step 302, the QR code 116 is printed on the product (the wallet 114) with the one or more details associated with the product (the wallet 114) using the QR code printing machine 101. The QR code 116 includes a unique product identifier (e.g. a unique QR code associated with the product). At step 304, the product (the wallet 114) is registered with the user 102 using the QR code 116 associated with the product (the wallet 114) once the user 102 bought the product (the wallet 114) using the user device 104. At step 306, the user data is obtained from the user 102 through the user device 104 using the user data obtaining module 202. At step 308, the QR codes of the one or more products are obtained from the user device 104 using the QR code obtaining module 204. At step 310, the ownership for the product (the wallet 114) is created by associating the user data with the QR code 116 that is specific to the product (the wallet 114) using the owner ship creating module 206. At step 312, the finder 110 who has the product (the wallet 114) that is misplaced or missed by the user 102 is identified using the finder identification module 208. The finder 110 is identified when the finder 110 scan the QR code 116 of the product (the wallet 114) using the finder device 112 that is other than the user device 104. At step 314, (a) a location of a user device (104) to the finder (110) and (b) an alert notification is provided to the user 102 using the finder identification module 208 when the finder 110 scans the QR code 116 of the product (the wallet 114). In one embodiment, a location of the user device 104 is provided to the finder 110 when the finder 110 scans the QR code 116 of the product (wallet). At step 316, chat or call is enabled between the user 102 and the finder 110 using the finder identification module 208. The QR code 116 includes an encrypted data to identify (a) the name and nature of the product (the wallet 114), (b) the manufacture of the product (the wallet 114) and (c) the unique product identifier.

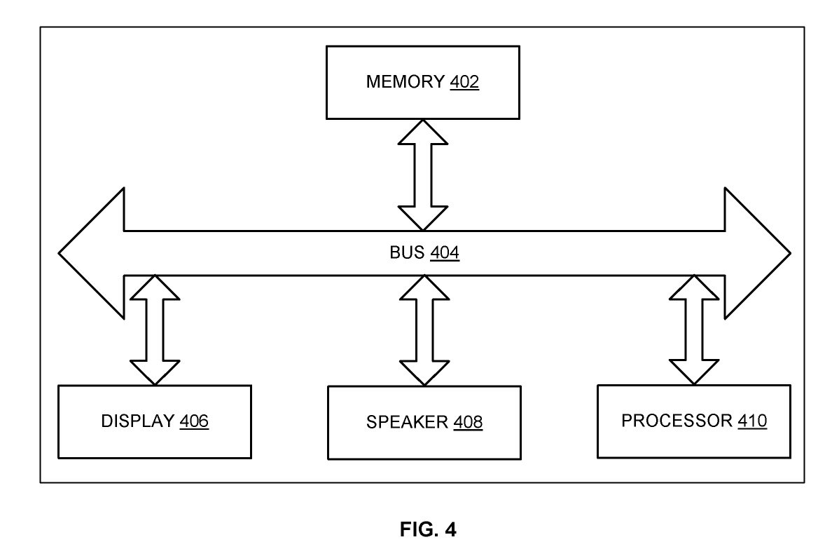

FIG. 4 illustrates an exploded view of the receiver having a memory 402 having a set of computer instructions, a bus 404, a display 406, a speaker 408, and a processor 410 capable of processing a set of instructions to perform any one or more of the methodologies herein, according to an embodiment herein. In one embodiment, the receiver may be the personal communication device. The processor 410 may also enable digital content to be consumed in the form of video for output via one or more displays 406 or audio for output via speaker and/or earphones 408. The processor 410 may also carry out the methods described herein and in accordance with the embodiments herein.

Digital content may also be stored in the memory 402 for future processing or consumption. The memory 402 may also store program specific information and/or service information (PSI/SI), including information about digital content (e.g., the detected information bits) available in the future or stored from the past. A user of the personal communication device may view this stored information on display 406 and select an item of for viewing, listening, or other uses via input, which may take the form of keypad, scroll, or other input device(s) or combinations thereof. When digital content is selected, the processor 410 may pass information. The content and PSI/SI may be passed among functions within the personal communication device using the bus 404.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly.

The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can take the form of, an entirely hardware embodiment, an entirely software embodiment or an embodiment including both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, remote controls, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

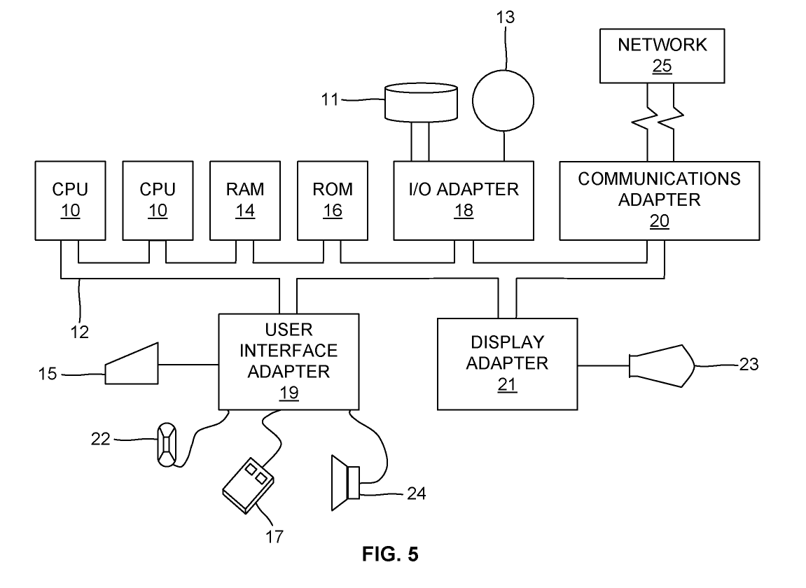

A representative hardware environment for practicing the embodiments herein is depicted in FIG. 5. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

I/We claim:

1. A system for locating a plurality of products that are misplaced by a user (102), wherein the system comprises:
(a) a QR code printing machine that prints a QR code (116) on a product (114) with a plurality of details associated with the product (114), wherein the QR code (116) comprises an encrypted data to identify a unique product identifier, wherein the encrypted data comprises a serial number of the product (114);
(b) a user device (104) that receives a user data from the user (102), wherein the user device (104) comprises a camera to read QR codes of the plurality of products; and
(c) a server (108), wherein the server (108) comprises:
a memory that stores (a) a set of modules and (b) a server database (200) that stores data associated with a plurality of users and data associated with a plurality of finders; and
a processor which executes the set of modules, wherein the set of modules comprises:
a user data obtaining module (202), implemented by the processor, that obtains the user data from the user (102) through the user device (104), wherein the user data comprises (i) a user device ID and (ii) an application ID;
a QR code obtaining module (204), implemented by the processor, that obtains the QR codes of the plurality of products from the user device (104);
an ownership creating module (206), implemented by the processor, that creates an ownership for the product (114) by associating the user data with the QR code (116) that is specific to the product (114); and
a finder identification module (208), implemented by the processor, that identifies a finder (110) who has the product (114) that is misplaced or missed by the user (102) when the finder (110) scan the QR code (116) of the product (114) using a device that is other than the user device (104), wherein the finder identification module (208) (i) provides an alert notification to the user (102) when the finder (110) scans the QR code (116) of the product (114) and (ii) enables chat or call between the user (102) and the finder (110), wherein the alert notification comprises a name of a finder (110), a contact detail of the finder (110) and a location of the finder (110).

2. The system as claimed in claim 1, wherein the server (108) further comprises an ownership transferring module (210), implemented by the processor, that transfers the ownership of the plurality of products to a second entity when the user (102) sell or provide the plurality of products to the second entity, wherein the ownership transferring module (210) (a) discards the user data associated with the respective QR codes of the plurality of products and associates data of the second entity with the QR codes of the plurality of products while transferring the ownership to the second entity.

3. The system as claimed in claim 1, wherein the server (108) further comprises a product details identification module (212), implemented by the processor, that identifies the plurality of details of the product (114) when the QR code (116) of the product (114) obtained from the user device (104).

4. The system as claimed in claim 1, wherein the finder identification module (208) identifies a location of the user device (104) when the finder (110) scans the QR code (116) of the product (114).

5. A method for locating a plurality of products that are misplaced by a user (102), wherein the method comprises:
printing, using a QR code printing machine (101), a QR code (116) on a product (114) with a plurality of details associated with the product (114), wherein the QR code (116) comprises an encrypted data to identify a unique product identifier;
registering, using a user device (104), the product (114) with the user (102) using the QR code (116) associated with the product (114) once the user (102) bought the product (114);
obtaining, using a user data obtaining module (202), the user data from the user (102) through the user device (104), wherein the user data comprises (i) the user device (104) ID and (ii) an application ID;
obtaining, using a QR code obtaining module (204), the QR codes of the plurality of products from the user device (104);
creating, using an owner ship creating module (206), an ownership for the product (114) by associating the user data with the QR code (116) that is specific to the product (114);
identifying, using a finder identification module (208), a finder (110) who has the product (114) that is misplaced or missed by the user (102) when the finder (110) scan the QR code (116) of the product (114) using a device that is other than the user device (104);
providing, using the finder identification module (208), (a) a location of a user device (104) to the finder (110) and (b) an alert notification to the user (102) when the finder (110) scans the QR code (116) of the product (114); and
enabling, using the finder identification module (208), chat or call between the user (102) and the finder (110).

6. The method as claimed in claim 5, comprising step of transferring, using an ownership transferring module (210), the ownership of the plurality of products to a second entity when the user (102) sell or provide the plurality of products to the second entity, wherein the ownership transferring module (210) associates data of the second entity with the respective QR codes of the plurality of products to transfer the ownership to the second entity.

7. The method as claimed in claim 5, comprising step of identifying, using a product details identification module (212), the plurality of details of the product (114) when the QR code (116) of the product (114) obtained from the user device (104).

8. The method as claimed in claim 5, comprising steps of
receiving, using the user device (104), the user data from the user (102); and
reading, using a camera, the QR codes of the plurality of products.
